(19) United States
(12) Patent Application Publication
(10) Pub. No.: US 2025/0119276 A1
(43) Pub. Date: Apr. 10, 2025

(54) DISTRIBUTED REGISTRATION METHOD FOR CONTROLLING ANONYMOUS ACCESS

(71) Applicant: UNIVERSITAT POLITÈCNICA DE VALÈNCIA, Valencia (ES)

(72) Inventors: Damián LÓPEZ RODRÍGUEZ, Valencia (ES); Antonio Manuel LARRIBA FLOR, Valencia (ES)

(21) Appl. No.: 18/694,744

(22) PCT Filed: Sep. 16, 2022
(86) PCT No.: PCT/ES2022/070587

§ 371 Date: Mar. 22, 2024

(30) Foreign Application Priority Data
Sep. 22, 2021 (ES) P202130890

(51) Int. Cl. H04L 9/08; G06F 21/62

(52) U.S. Cl. CPC H04L 9/085; G06F 21/62; H04L 9/0869; H04L 2209/46

(57) ABSTRACT

The present invention relates to a method for controlling access to remote resources with D distributors and N guards, said method comprising generating a qᵢ(x) function or a mᵢ value by means of each distributor; dividing each qᵢ(x) function or each mᵢ value into N portions; sending one portion to each guard; a user sending an identifier and a Pₜᵤ value to the distributors; calculating and sending to the user the result of the qᵢ(Pₜᵤ) function or Pₜᵤ^{m}^{ᵢ} value; a user calculating a yᵤ value equal to the sum total of the results of qᵢ(Pₜᵤ) or the product total of the Pₜᵤ^{m}^{ᵢ}; each guard calculating its own pⱼ(x) function or its own nⱼ value; a user sending to each guard the Pₜᵤ and yᵤ values; each guard calculating the value of the its own pⱼ(Pₜᵤ) function or the product total of the Pₜᵤ^{nj} values; communicating to the rest of the guards the obtained pⱼ(x) values; verifying yᵤ; and giving access to the resource.

### OBJECT OF THE INVENTION

The invention relates to a distributed registration method and system for controlling anonymous access to resources and services.

A first object of the invention relates to a computer-assisted distributed registration method that allows controlling access with limited communication between parties, minimal user interaction, and without the need to store identification information.

Another object of the invention relates to a distributed registration system comprising means for managing anonymous access to resources and services.

### BACKGROUND OF THE INVENTION

There are various solutions in the field of anonymous authentication methods and systems.

Some solutions, such as those reflected in documents WO2008065341A2 (MAIDSAFE FOUND) and GB2444346, relate to distributed network systems that provide privacy, security, and freedom to their users, facilitating their intercommunication and anonymous access to their own or shared resources. These systems allow access by means of anonymous authentication using encryption algorithms.

In turn, document WO2017145010A1 (NCHAIN HOLDINGS) describes a computer-implemented method which controls access to a digital wallet implemented using blockchain technology. The method divides a verification element (private key) into multiple fractions that are transmitted by means of a common secret between two or more nodes. To divide the secret S into fractions (n being the number of participants), a polynomial y=f(x) of degree k−1 (mod p) is constructed in a random or pseudo-random manner, where k is a threshold number and p a prime number, such that the secret can be divided into portions and later reconstructed by means of a set of known points.

Document CN111416705A (NANJING RUBAN QUANTUM TECHNOLOGY) introduces a system and method for electronic voting based on cryptographic anonymous identification, blockchain, and secret sharing technologies, capable of resisting quantum computing attacks and reducing computing times for the use of blind digital signatures.

Document ES2255455A1 (SCYTL ON LINE WORLD SECURITY) describes a method to securely conduct electronic voting and poll over a communications network by means of interrelated cryptographic processes and protocols, designed to facilitate the tasks of vote casting, counting, and secure verification, allowing voter privacy, result accuracy, and the impossibility of coercion and sale of votes.

However, the solutions provided by the state of the art do not allow controlling access to a guarded resource in a distributed, efficient, and simpler manner with less computational cost for the parties.

### DESCRIPTION OF THE INVENTION

The present invention relates to a computer-assisted method for controlling anonymous and distributed access to remote resources or services which uses one or more central authorities, or distributors, and N authorities responsible for controlling access to the resource or service, referred to as guards, wherein N is greater than or equal to 1, and wherein the method comprises the steps of:
each of the distributors generating a qᵢ(x) function or a mᵢ value;
   dividing each qᵢ(x) function or each mᵢ value into N portions (qᵢⱼ(x) or mᵢⱼ), such that the qᵢ(x) function is a linear combination of the qᵢⱼ(x) portions or the mᵢ value is equal to the sum total of the N portions mᵢⱼ;
   each distributor sending a portion of its qᵢⱼ(x) function or its mᵢⱼ value to each guard;
   if there is more than one distributor, each guard calculating its own pⱼ(x) function equal to the sum total of the functions received from each distributor or its own nⱼ value equal to the sum total of the values mᵢⱼ received from each distributor;
   the user sending one or more distributors an identifier and a Pₜᵤ value;
   one or more distributors calculating and sending to the user the result of the generated qᵢ(x) function for Pₜᵤ or the Pu value reduction modulo p, where p is a value previously agreed upon;
   if there is more than one distributor, the user calculating a yᵤ value equal to the reduction modulo p of the sum total of the results of the generated qᵢ(x) function of each distributor for Pₜᵤ or of the product total of the results of the Pₜᵤ^{m}^{ᵢ} value of each distributor;
   sending to each guard the Pₜᵤ and yᵤ values;
   each guard calculating the result for Pₜᵤ of its own function pⱼ(x) or the result of Pₜ modulo p using its own nⱼ value;
   verifying that yᵤ is equal to the reduction modulo p of the sum of the result of all own pⱼ(x) functions or the product total of the Pₜᵤ^{nj} values using own nⱼ values;
   giving access to a resource if the verification is positive.

Two different methods for controlling access to a remote resource (such as an electronic voting ballot box, a blockchain, or a smart parcel box, for example) that solve the problem in controlling distributed and anonymous access to a guarded resource, can preferably be obtained from the steps of the method.

Therefore, the aim is to give access to a resource guarded by a set of guards that distrust one another. To access the resource, all the guards must verify that the credentials presented are correct. At the same time, the credentials must not reveal any type of information about the user seeking access, guaranteeing the owner of the credential a single access to the resource.

The first method preferably has a respectable central authority (distributor) that is assumed to be honest and is responsible for generating access credentials, regardless of the form they may take.

Furthermore, a set of N authorities responsible for controlling access to a certain resource or service (or guards) is incorporated. The set of guards does not consider the distributor as a member. The scenario is completed with a set of m duly identified users.

The distributor's job is twofold: first, it establishes the system by distributing credentials (regardless of the form they may take) to users and validation tools to guards and, secondly, it is responsible for auditing possible identification errors among the users and guards.

On the one hand, only the distributor can link users to their credentials; on the other hand, the distributor is not provided with any information about how that protected resource will be used.

Therefore, in this first method the following set of steps is followed:

### 1. System Configuration

1.1. The central authority (or distributor) distributes enough information to the access control authorities (or guards) that it is necessary for them all to collaborate to agree on the validity of a credential.
1.2. The distributor generates sufficient structures to check for the prior issuance of credentials to users.

### 2. User Identification and Registration

2.1. A user sends his/her identification to the central authority.
2.2. The central authority verifies the received identification and the prior issuance of credentials to that user.
2.3. If the checking of identification and prior issuance so allow, an anonymous access credential is returned to the user.

### 3. Access Control

3.1. The users send their access credential to all guards and the action to be performed on the resource.
3.2. The guards collectively agree on the validity or non-validity of the credential.
3.3. If correct, the action indicated by the user is performed.
3.4. The guards provide the user with guarantee that the action has been performed or provide the user with permission to perform the action.

### 4. Guard Audit

4.1. If necessary (denial of access), the user can turn to the distributor to detect errors or malicious behaviour of any of the guards.

The second method furthermore allows distributing the responsibility for generating access credentials among a set of accredited authorities or distributors.

Likewise, a set of N authorities, which is distinct from the set of distributors responsible for controlling access (or guards), and a set of m duly identified users are included.

Therefore, in this second method the following set of steps is followed:

### 1. System Configuration

1.1. Each of the distributors generates sufficient structures to be able to check for the prior issuance of credentials to users.
1.2. Each of the registration authorities (distributors) sends to all the access control authorities (guards) individualised information to participate in access control.
1.3. Each of the guards configures, with the information received from each and every one of the distributors, their access control tool.

### 2. User Identification and Registration

2.1. The users send to each and every one of the distributors, their identification along with a prior credential to build the accreditation therefrom.
2.2. Each of the distributors verifies the identification credentials received, returning to the user, if said credentials are correct, an anonymous access accreditation component built from the prior credential received. Therefore, this accreditation component, in isolation, is not valid for access to the resource.
2.3. Once all the accreditation components have been received, the user combines all of them to obtain the access accreditation.

### 3. Access Control

3.1. The users send their access credential to all guards and the action to be performed on the resource.
3.2. The guards collectively agree on the validity or non-validity of the credential.
3.3. If the credentials are correct, the indicated action is performed, or the user is enabled to perform it.
3.4. If the action is performed, the guards provide the user with a guarantee that the action has been performed.

### 4. Guard Audit

4.1. If necessary (such as denial of access, for example), a user can turn to the distributors to detect errors or malicious behaviour of any of the guards.

In this second method, it is considered that the prior credential and the received accreditation component can allow the user to obtain an anonymous credential that is impossible for distributors to link to his/her identity.

The invention also relates to a system for controlling anonymous and distributed access to remote resources or services comprising a first set of one or more processing units acting as distributors, a second set of one or more processing units acting as guards, and a third set of one or more processing units acting as users, configured for carrying out the steps of the described method.

Some of the possible applications of the method of the invention are, among others:
Electronic voting: For controlling access to the voters' ballot box and its unique access, maintaining and respecting privacy so that the vote remains secret.
Access to blockchains: For controlling user access in a blockchain environment, preventing the “double spending” problem that would allow malicious users to spend more resources (coins) than they actually have.
Credit cards: For generating access credentials but requiring that the credential be only known to the user and not be stored on any server.
Access to smart parcel boxes: Allowing courier companies to control user access to lockers (guaranteeing single access to them), with the possibility of distributing access control between the locker itself, the courier company, and the user.
Secret sharing: By means of a counter guarded by guards to manage a “secret” (regardless of the form it may take) that should only be accessible to the members of a group, being able to force the “secret” to be only accessible if all users of the group consider it as such.

Likewise, the following advantages are identified with respect to solutions of the state of the art:
The protocols allow unidentified user access, allowing use thereof in sensitive contexts.
It distributes access control, and even the attainment of credentials, maintaining the anonymity of users with respect to access control authorities or distributors.
Despite distributing access control, communication between the different parties is limited, allowing a low computational cost implementation.
User interaction is minimal. It only required one message to obtain credentials and another message to access the resource. It is a protocol that does not require active user participation, in which the authorities do not depend on the user response, reducing the dialogue between the parties involved, so the execution of the phases is not blocked waiting for previous results, reducing the possibility of denial-of-service attacks.
It can be implemented without storing information on servers that act as guards or distributors, being resistant to various types of attacks.

In summary, the method of the invention solves the problem of access to a guarded resource in a distributed, efficient, and simpler manner insofar as the dialogue between the different parties involved is reduced and with less computational cost for the parties.

### DESCRIPTION OF THE DRAWINGS

In order to complement the description being made and with the object of helping to better understand the features of the invention, in accordance with a preferred practical exemplary embodiment thereof, said description is accompanied, as an integral part thereof, by a set of drawings where, in an illustrative and non-limiting manner, the following has been represented:

FIG. 1 shows a block diagram depicting a preferred embodiment of the first implementation of the method of the invention.

FIG. 2 shows a block diagram depicting a preferred embodiment of the second implementation of the method of the invention.

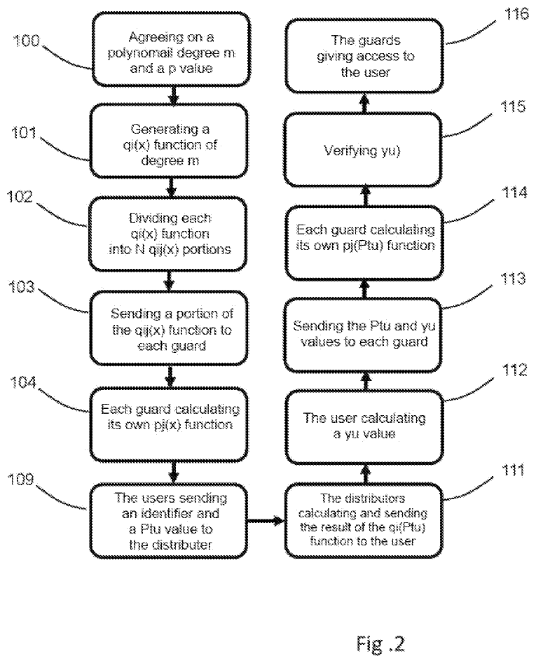

FIG. 3 shows a diagram of the distribution of the polynomials generated by the distributors among the guards and the generation of the own function of each guard.

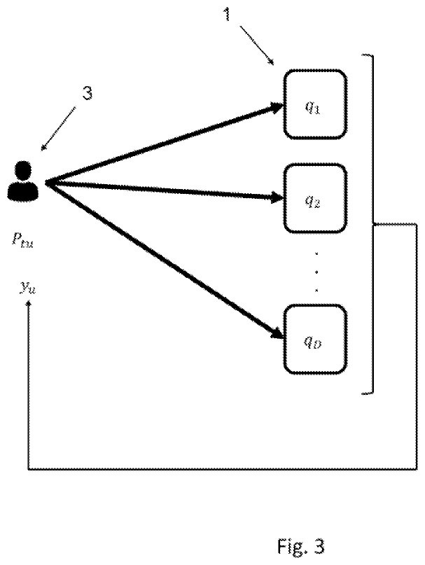

FIG. 4 shows a diagram of the identification and assignment of credentials to a user who sends his/her identification to the distributors.

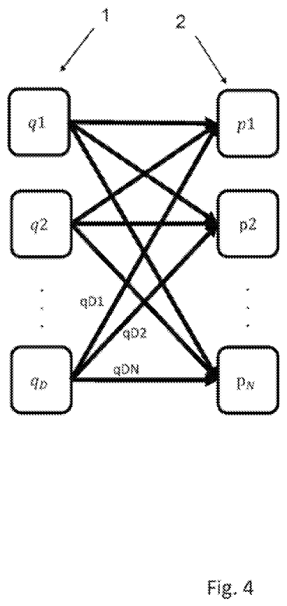

FIG. 5 shows a block diagram depicting a preferred embodiment of the third implementation of the method of the invention.

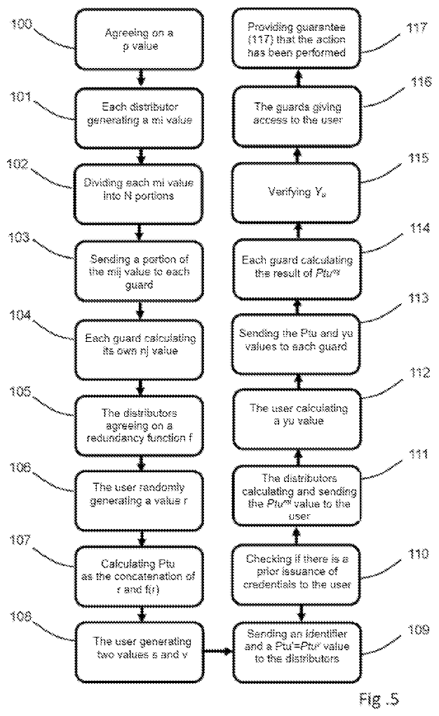

### PREFERRED EMBODIMENT OF THE INVENTION

The present invention relates to a method for controlling anonymous and distributed access which allows controlling access to a resource or service anonymously and distributing access control and credential generation.

Three implementation examples with post-quantum security and/or anonymity properties are presented below.

The first example allows providing single-use credentials, guaranteeing the maintenance of user anonymity along with the guarantee that, unless all access control authorities (guards) are compromised, it is not possible to fraudulently generate valid credentials.

In this case, the existence of an honest central entity that acts as distributor (1) is assumed, the method also comprises a set of N guards (2) responsible for controlling access and a set of duly accredited m users (3).

The distributor (1) is responsible for establishing the system by distributing credentials to users (3) and auditing possible identification errors among the users (3) and guards (2).

On the one hand, in this case, only the distributor (1) can link users (3) to their credentials; while on the other hand, the distributor (1) is not provided with any information about how the protected resource will be used.

This first embodiment of the method of the invention begins with the generation (100) of a sufficiently large prime number p, and the generation (101) of a polynomial of degree m, taking into consideration the result modulo p, when it is necessary to calculate the value of the polynomial for a specific value x. The value of m, the maximum degree of the polynomial, must be less than p−1, and it is not necessary to take into consideration a polynomial with all coefficients other than zero:

$$q ( x ) = {a}_{m} {x}^{m} + {a}_{m - 1} {x}^{m - 1} + … + {a}_{1} x + {a}_{o} mod p$$

Once q(x) is generated, the authority divides (102) it into N polynomials (pⱼ(x)):

$${q}_{1} ( x ) = {a}_{1 m} {x}^{m} + {a}_{1 m - 1} {x}^{m - 1} + … + {a}_{11} x + \begin{matrix}{a}_{10} & mod p\end{matrix}$$

$$\begin{matrix}{q}_{2} ( x ) = {a}_{2 m} {x}^{m} + {a}_{2 m - 1} {x}^{m - 1} + … + {a}_{21} x + {a}_{20} & mod p \\ {q}_{N} ( x ) = {a}_{Nm} {x}^{m} + {a}_{Nm - 1} {x}^{m - 1} + … + {a}_{N 1} x + {a}_{N 0} & mod p\end{matrix}$$

such that the fractional polynomials complement one another to obtain the coefficients of q(x), in other words:

$${a}_{i} = {\sum }_{1 \leq j \leq N} {a}_{ji} \qquad ∀ i , 0 \leq i \leq m$$

Each of the fractional polynomials is assigned and sent (103) securely to each of the guards (2). Therefore, unless all guards (2) collaborate, it is impossible for a subset of guards (2) to obtain the original polynomial q(x).

Once the system has been configured, users (3) are allowed to obtain their credentials. To that end, the users (3) send (109) their identifications to the distributor (1), which once verified as relevant, the distributor (1) generates a random Pₜᵤ value and use the polynomial to calculate and send (111) to the user (3) the (Pₜᵤ,q(Pₜᵤ)) point of the polynomial q(x). These points function as anonymous credentials for the guards (2) that guard the resource. The distributor (1) is responsible for not generating two points with the same Pₜᵤ coordinate.

Unless the number of users (3) exceeds the limit m, it is impossible for any set of users (3) to forge new credentials.

In the proposed method, the size of modulo p has no relevant influence on the security of the system, but it must be greater than m. Furthermore, the use of modular arithmetic limits the size of credentials while not restricting working with a large number of users (3). Therefore, for example, a value of m of 30 bits is not large in terms of computational time and is large enough to provide credentials to everyone on earth.

Once the credentials have been delivered, for the users (3) to be able to access the resource or service, they must send (113) their credentials to all the guards (2) which calculate (114) the result of pⱼ(Pₜᵤ), and collaborate to verify (115) that the received credential (Pₜᵤ,q(Pₜᵤ)) meets the following:

$$q ( {P}_{tu} ) = {\sum }_{1 \leq i \leq N} {q}_{i} ( {P}_{tu} ) mod p$$

Finally, access is given (116) to the user (3) after the guards (2) verify the received credential.

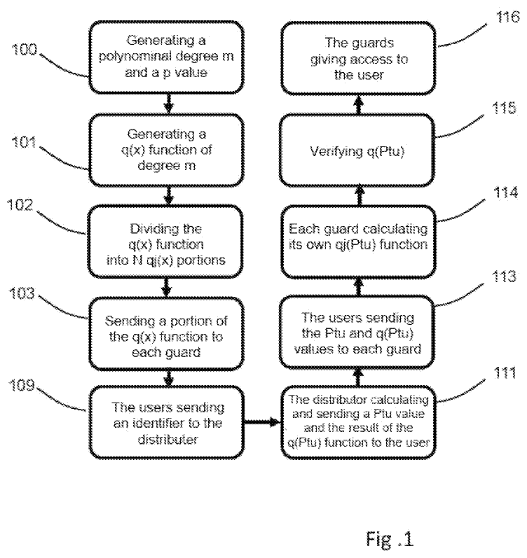

FIG. 1 shows a diagram of the first embodiment of the method of the invention. This implementation provides the possibility of accessing a resource anonymously.

The second implementation distributes credential generation among a set of D distributors (1) that are assumed to be honest, guaranteeing the anonymity of the users (3) with respect to the guards (2) and the impossibility of generating fraudulent accreditations, even in a post-quantum scenario, unless either all the distributors (1) or all the guards (2) agree to violate the system.

To initially configure the system, the distributors (1) first agree (100) on a modular value p and the degree m of a polynomial q(x) to be built. Next, each distributor (1) independently generates (101) a polynomial qᵢ(x) of degree m and modulo p. This polynomial qᵢ(x) is divided (102) independently and freely into N complementary gᵢⱼ(x) portions, such that:

$${q}_{i} ( x ) = ( {\sum }_{j = 1}^{N} {q}_{ij} ( x ) ) mod p$$

Next, the distributors (1) send (103) over a secure channel to each guard (2) one of the partitions qᵢⱼ. In this way, each guard (2) receives the partitions from each of the distributors (1) and calculates (104) its own polynomial pⱼ(x) as:

$${p}_{j} ( x ) = ( {\sum }_{i = 1}^{D} {q}_{ij} ( x ) ) mod p$$

Therefore, pⱼ(x) is the result of adding up all the functions received from each distributor (1), such that the polynomial of each guard (2) cannot be known by any distributor (1), unless all of them agree to share their polynomial qᵢ(x) and violate the system.

Furthermore, with respect to the polynomials known by the distributors (1) and the guards (2), the following is met:

$${\sum }_{i = 1}^{D} {q}_{i} ( x ) mod p = {\sum }_{j = 1}^{N} {p}_{j} ( x ) mod p$$

To obtain their credentials, the users (3) send (109) their identification along with a Pₜᵤ integer such that p>Pₜᵤ to each of the distributors (1). These are responsible for ensuring that there are no duplicates of Pₜᵤ, in which case, the user (3) will be prompted to choose a different Pₜᵤ or he/she will be assigned one agreed upon by the distributors (1).

Each distributor (1) checks the identification of the user (3) and, if it is correct, responds by calculating and sending (111) the result of qᵢ(Pₜᵤ) mod p. Once the response is received from all the distributors (1), the users (3) can calculate (112) their credentials as:

$$( {P}_{tu} , {y}_{u} = ( {\sum }_{i = 1}^{D} {q}_{i} ( {P}_{tu} ) ) mod p )$$

Once the credentials have been delivered, for the users to be able to access the resource or service, they must send (113) their credentials (Pₜᵤ,yᵤ) to all the guards which must calculate (114) the result of pⱼ(Pₜᵤ), and collaborate to verify (115) that the received credential meets the following:

$${y}_{u} = ( {\sum }_{1 \leq i \leq N} {p}_{j} ( {P}_{tu} ) ) mod p$$

Finally, access is given (116) to the user (3) after the guards (2) verify the received credential.

The third proposed implementation allows maintaining the anonymity of users (3) also with respect to the distributors (1). In fact, this implementation guarantees the anonymity of users (3) with respect to any authority involved, making it impossible for information extracted from compromised authorities to allow the generation of malicious credentials as long as there is an uncompromised authority and there is no solution for the discrete logarithm problem (current basis of security in public key cryptographic systems).

Therefore, this implementation allows the privacy of the user (3) to be protected during the registration phase, eliminating the connection existing between the identity of the user (3) and his/her credentials. For this work, homomorphic cryptography is used to hide the credential information that distributors (1) have access to. The implementation presented guarantees the anonymity of users (3) with respect to the authorities (even in post-quantum scenarios), preventing the generation of malicious credentials as long as the problem of the discrete logarithm (basis of many current public key cryptographic protocols) remain secure.

In this implementation, D distributors (1) responsible for generating access credentials and a group of N guards (2) are taken into consideration.

The configuration of the system implies that the distributors (1) agree (100) in advance on a prime modular value p, and that each of the distributors (1) generates (101) a random mᵢ integer less than (p−1). Furthermore, the distributors (1) agree (105) on a redundancy function ƒ(x). Next, each distributor (1) divides (102) the mᵢ integer into N portions such that:

$${m}_{i} = {\sum }_{j = 1}^{N} {m}_{ij} mod p$$

The portions mᵢⱼ are sent (103) to the guards (2) through secure channels. Each guard (2) can then calculate (104) its own value from the portions received from the distributors (1):

$${n}_{j} = ( {\sum }_{i = 1}^{N} {m}_{ij} ) mod p$$

Therefore, at the end of the distribution phase, both the distributors (1) and the guards (2) have different information to build the same secret integer m that is never stored anywhere. That is, m is the result of the sums:

$$m = {\sum }_{i = 1}^{D} {m}_{i} mod p = {\sum }_{j = 1}^{N} {n}_{j} mod p$$

In the identification phase, before starting communication with the distributors (1), each user (3) generates (108) a pair of integers s and v such that the product v*s reduction modulo (p−1) is equal to 1. The registration phase begins when user u privately selects an integer Pₜᵤ, which, to avoid attacks based on the homomorphic properties of the modular product, contains the result of a redundancy function previously agreed upon (105). Thus, Pₜᵤ it is calculated (107) as the result of the concatenation of a random value r previously generated (106) and the result of ƒ(r).

The generated value will be part of the credential of the user (3), so in order for the distributors (1) to not be able to link the received credential to the identifier of the user (3), the integer Pₜᵤ is masked as P′ₜᵤ=Pₜᵤ^{v} mod p before sending (109) the user identification along with the P′ₜᵤ value to each of the distributors (1).

If the identification is correct and it is previously checked (110) that there is no prior issuance of credentials to said user (3), each distributor (1) calculates and sends (111) the (P′ₜᵤ)^{m}^{ᵢ} value reduction modulo p to the user.

For a sufficiently large p value, the probability that two users (3) generate the same Pₜᵤ is extremely low, practically negligible with p values of 1024 bits, which is a conservative number of bits by current standards.

Once the response from the distributors (1) is received, the user (3) can calculate (112) his/her access credentials as:

$$( {x}_{u} , {y}_{u} = {\prod }_{i = 1}^{D} {( {( {P}_{tu}^{′} )}^{{m}_{i}} )}^{s} mod p )$$

Such that:

$${y}_{u} = {\prod }_{i = 1}^{D} {( {( {P}_{tu}^{′} )}^{{m}_{i}} )}^{s} mod p = {\prod }_{i = 1}^{D} {( {( {P}_{tu}^{v} )}^{s} )}^{{m}_{i}} mod p = {P}_{tu}^{{\sum }_{i = 1}^{D} {m}_{i}} mod p = {P}_{tu}^{m} mod p$$

where m is the integer previously agreed upon, but unknown to both guards (2) and distributors (1).

Furthermore, P′ₜᵤ=Pₜᵤ^{v} mod p is the only value transmitted to the distributors and is insufficient to reveal the hidden Pₜᵤ value. Once the credentials have been delivered, for the users (3) to be able to access (116) the resource or service, they must send (113) their credentials to all the guards which must calculate (114) the result of (Pₜᵤⁿ^{ⱼ}) and collaborate to verify (115) that the received credential meets the following:

$${y}_{u} = {\prod }_{1 \leq j \leq N} {( {P}_{tu} )}^{{n}_{j}} mod p$$

Finally, access (116) is given to the user (3) after the guards (2) verify the received credential, or the requested action (116) is performed, and the user (3) is provided with guarantee (117) that the action has been performed.

1. A computer-assisted method for controlling anonymous and distributed access to remote resources or services which uses one or more central authorities, or distributors (1), and N authorities responsible for controlling access to the resource or service, referred to as guards (2), wherein N is greater than or equal to 1, and wherein the method comprises the steps of:
the distributors (1) agreeing (100) on a prime p value, such that the generated polynomial qᵢ(x) is obtained taking into consideration the result reduction modulo p;
each of the distributors (1) generating (101) a qᵢ(x) function or a mᵢ value;
dividing (102) each qᵢ(x) function or each mg value into N portions, such that the qᵢ(x) function is a linear combination of the qᵢⱼ(x) portions or the mᵢ value is equal to the sum total of the N portions mᵢⱼ;
each distributor (1) sending (103) a portion of its qᵢⱼ(x) function or its mᵢⱼ value to each guard (2);
if there is more than one distributor (1), each guard (2) calculating (104) its own pⱼ(x) function equal to the sum total of the functions received from each distributor or its own nⱼ value equal to the sum total of the values received from each distributor;
a user (3) sending (109) to the one or more distributors an identifier and, if more than one distributor is taken into consideration, a Pₜᵤ value;
one or more distributors (1) calculating and sending (111) to the user (3) the result of the generated qᵢ(x) function for Pₜᵤ or the Pₜᵤ^{m}^{ᵢ} value if the identification is positive;
if there is more than one distributor (1), the user calculating (112) a yᵤ value equal to the reduction modulo p of the sum total of the results of the generated qᵢ(x) function of each distributor (1) for Pₜᵤ or of the product total of the results of the Pₜᵤ^{m}^{ᵢ} value of each distributor (1);
sending (113) to each guard (2) the Pₜᵤ and yᵤ values;
each guard (2) calculating (114) the result for Pₜᵤ of its own function pⱼ(x) or the result of Pₜᵤ^{m}^{ⱼ} modulo p using its own nⱼ value;
verifying (115) that yᵤ is equal to the reduction modulo p of the sum of the result of all own pⱼ(x) functions or the product total of the Pₜᵤ^{mj} values using own nⱼ values;
giving access (116) to a resource if the verification is positive.

2. The method according to claim 1, wherein the distributors (1) agree (105) on a redundancy function f and the user (3) randomly generates (106) a value r, such that Pₜᵤ is calculated (107) as the concatenation of r and f(r).

3. The method according to any of claims 1 to 2, wherein, if there is more than one distributor (1), the user (3) generates two values (108) s and v, such that the product s*v reduction modulo (p−1) is equal to 1; and wherein the value that is sent (109) to the one or more distributors along with the identifier is P′ₜᵤ=Pₜᵤ^{v} modulo p and yᵤ is equal to the product total of the (Pₜᵤ^{mj})^{s} values.

4. The method according to any of claims 1 to 3, wherein in the step of the one or more distributors (1) calculating and sending (111) to the user (3) the result of the generated qᵢ(x) function for Pₜᵤ or of the Pₜᵤ^{m}^{ᵢ} value, it is previously checked (110) if there is a previous issuance of credentials to said user (3).

5. The method according to any of claims 1 to 4, wherein the user (3) specifies an action to be performed on a resource to the guards (2), which perform said action or give access (116) to the user (3) to perform the action if the verification step is positive and provide the user (3) with guarantee (117) that the action has been performed.

6. A system for controlling anonymous and distributed access to remote resources or services comprising a first set of one or more processing units acting as distributors, a second set of one or more processing units acting as guards, and a third set of one or more processing units acting as users, configured for carrying out the steps of:
each of the distributors (1) generating (101) a qᵢ(x) function or a mᵢ value;
dividing (102) each qᵢ(x) function or each mᵢ value into N portions, such that the qᵢ(x) function is a linear combination of the qᵢⱼ(x) portions or the mᵢ value is equal to the sum total of the N portions mᵢⱼ;
each distributor (1) sending (103) a portion of its qᵢⱼ(x) function or its mᵢⱼ value to each guard (2);
if there is more than one distributor (1), each guard (2) calculating (104) its own pⱼ(x) function equal to the sum total of the functions received from each distributor or its own nⱼ value equal to the sum total of the values received from each distributor;
a user (3) sending (109) to the one or more distributors an identifier and a Pₜᵤ value;
one or more distributors (1) calculating and sending (111) to the user (3) the result of the generated qᵢ(x) function for Pₜᵤ or the Pₜᵤ^{m}^{ᵢ} value if the identification is positive;
if there is more than one distributor (1), the user calculating (112) a yᵤ value equal to the reduction modulo p of the sum total of the results of the generated qᵢ(x) function of each distributor (1) for Pₜᵤ or of the product total of the results of the Pₜᵤ^{m}^{ᵢ} value of each distributor (1);
sending (113) to each guard (2) the Pₜᵤ and yᵤ values;
each guard (2) calculating (114) the result for Pₜᵤ of its own function pⱼ(x) or the result of Pₜᵤ^{m}^{ⱼ} modulo p using its own nⱼ value;
verifying (115) that yᵤ is equal to the reduction modulo p of the sum of the result of all own pⱼ(x) functions or the product total of the Pₜᵤ^{mj} values using own nⱼ values;
giving access (116) to a resource if the verification is positive.

7. A computer program, characterised in that it is adapted to cause the processing units to perform the steps of the method according to any of claims 1 to 5.

8. A machine-readable storage device, characterised in that it comprises the computer program according to claim 7.
